(19) United States
(12) Patent Application Publication
(10) Pub. No.: US 2011/0287355 A1
(43) Pub. Date: Nov. 24, 2011

(54) ELECTROPHOTOGRAPHIC TONER

(75) Inventor: Motonari Udo, Shizuoka-ken (JP)

(73) Assignee: TOSHIBA TEC KABUSHIKI KAISHA, Tokyo (JP)

(21) Appl. No.: 13/110,226

(22) Filed: May 18, 2011

Related U.S. Application Data
(60) Provisional application No. 61/346,710, filed on May 20, 2010.

(51) Int. Cl. G03G 9/08; G03G 9/087

(52) U.S. Cl. 430/108.6

(57) ABSTRACT

Disclosed is an electrophotographic toner, including toner particles which contain at least a binder resin and a coloring agent and have been prepared in an aqueous medium, wherein the surfaces of the toner particles are treated with an Si compound in an amount of from 0.1 to 5.0 wt % calculated as SiO₂ and with a Ti oxide in an amount of from 0.1 to 3.0 wt % calculated as TiO₂. The toner has a dielectric loss (tan δ) of from 1×10³ to 10×10³ in an environment of 10° C. and 20% relative humidity (RH) and from 3×10³ to 15×10³ in an environment of 30° C. and 85% RH, and also has a triboelectric charge (q/m) of from 20 to 50 μC/g in an environment of 10° C. and 20% RH and from 10 to 35 μC/g in an environment of 30° C. and 85% RH. According to this configuration, electrophotographic properties are improved as represented by: a low environmental variation in chargeability; a decrease in amount of scattered toner; and less fogging.

### CROSS-REFERENCE TO RELATED APPLICATION

This application is based upon and claims the benefit of priority from: U.S. provisional application 61/346,710, filed on May 20, 2010, the entire contents of which are incorporated herein by reference.

### FIELD

Embodiments described herein relate generally to an electrophotographic toner, particularly to a toner having improved image-forming performances by controlling dielectric properties and charging properties.

### BACKGROUND

In an electrophotographic process, an electric latent image is formed on an image carrier, the latent image is developed with a toner, and the toner image is transferred onto a transfer material such as paper and then fixed thereon by heating, pressing, and the like. As for the toner to be used, in order to form a full color image, not only a conventional toner of a single color of black, but also toners of a plurality of colors are used to form an image.

As for the use of the toner, a two-component developer in which the toner is used by mixing with carrier particles and a one-component developer in which the toner is used as a magnetic toner or a non-magnetic toner are known. Such a toner is produced by a dry process or a wet process. A kneading and pulverization method, which is a dry process, is a method for producing desired toner particles by melt-kneading a binder resin, a pigment, a release agent such as a wax, a charge control agent, and the like, cooling the resulting mixture, followed by finely pulverizing the cooled mixture, and then classifying the finely pulverized mixture. Inorganic and/or organic fine particles are added for attaching to the surfaces of toner particles produced by the kneading and pulverization method in accordance with the intended use, and thus, the toner can be obtained.

When toner particles are produced by the kneading and pulverization method, their shape is indefinite and their surface composition is not uniform in general. Although the shape and surface composition of toner particles are subtly changed depending on the pulverizability of the material to be used and conditions for the pulverization step, it is not easy to intentionally control the shape.

Further, as the wet process, there is employed a method for obtaining toner particles by preparing a resin dispersion liquid through emulsion polymerization or the like, and also separately preparing a coloring agent dispersion liquid in which a coloring agent is dispersed in a solvent, mixing these dispersion liquids to form aggregated particles with a size corresponding to a toner particle diameter, and fusing the aggregated particles by heating. According to this emulsion polymerization aggregation method, the toner shape can be arbitrarily controlled from an indefinite to a spherical shape by the selection of a heating temperature condition. The wet process includes an emulsion polymerization aggregation method (JP-A-63-282752 and JP-A-6-250439), a phase-inversion emulsification method in which a pigment dispersion liquid or the like is added to a solution obtained by dissolving a resin in an organic solvent, and water is added thereto, and a mechanical shearing and aggregation method in which fine particles are prepared by mechanical shearing in an aqueous medium without using an organic solvent, followed by aggregation and fusion (JP-A-9-311502). A method for producing a toner by a wet process in which colored fine particles in an aqueous dispersion liquid are aggregated and then fused is particularly preferred because the method allows the control of the circularity or sphericity of the toner during the fusion step. However, the method for producing a toner by a wet process has a problem that a surfactant, an electrolyte, or the like added in the step of dispersion or aggregation is incorporated in toner particles to be formed, and the image-forming performance of the resulting toner is not stable.

### DESCRIPTION OF THE DRAWINGS

FIG. 1 is a graph showing overall plots of the dielectric losses (tan δ) and triboelectric charges (q/m) of toners obtained in Examples and Comparative Examples in an LL environment and an HH environment.

FIG. 2 is a graph showing correlative plots between the difference in triboelectric charge (q/m (LL-HH)) between those measured in an LL environment and those measured in an HH environment and the amount of scattered toner for toners obtained in Examples and Comparative Examples.

### DETAILED DESCRIPTION

In an exemplary embodiment, by controlling the dielectric properties and triboelectric charging properties of a toner formed by an aggregation and fusion method from an aqueous fine particle dispersion system, a toner having a stabilized image-forming ability can be formed.

Hereinafter, an exemplary embodiment will be described. In the following description, “part(s)” and “%” representing the composition are expressed by weight unless otherwise stated.

According to an exemplary embodiment, there is provided an electrophotographic toner containing toner particles which contain at least a binder resin and a coloring agent, and are formed by an aggregation and fusion method from an aqueous fine particle dispersion system, wherein an Si compound is externally added in an amount of from 0.1 to 5.0 wt % calculated as SiO₂ and also a Ti oxide is externally added in an amount of from 0.1 to 3.0 wt % calculated as TiO₂, respectively based on the toner particles. The toner has a dielectric loss (tan δ) of from 1×10³ to 10×10³ in an environment of 10° C. and 20% relative humidity (RH) and from 3×10³ to 15×10³ in an environment of 30° C. and 85% RH, and also has a triboelectric charge (q/m) of from 20 to 50 μC/g in an environment of 10° C. and 20% RH and from 10 to 35 μC/g in an environment of 30° C. and 85% RH. The toner has a characteristic that variations in dielectric loss (tan δ) and triboelectric charge (q/m) between an environment of 10° C. and 20% RH (hereinafter often referred to as “LL environment”) and an environment of 30° C. and 85% RH (hereinafter often referred to as “HH environment”) are small. A low dielectric loss (tan δ) in the HH environment indicates that favorable insulation properties are maintained, and a small variation in triboelectric charge (q/m) between the LL environment and the HH environment (q/m (LL-HH)) contributes to a reduction in amount of toner to be scattered.

### (Starting Materials for Toner)

As starting materials for producing the toner according to an exemplary embodiment, any known materials such as a resin, a coloring agent, a color-forming compound, a color-developing agent, a release agent, a charge control agent, an aggregating agent, and a neutralizing agent, can be used.

### [Resin]

Examples of the binder resin to be used in an exemplary embodiment include styrene resins, such as polystyrene, styrene/butadiene copolymers, and styrene/acrylic copolymers; ethylene resins, such as polyethylene, polyethylene/vinyl acetate copolymers, polyethylene/norbornene copolymers, and polyethylene/vinyl alcohol copolymers; polyester resins, acrylic resins, phenolic resins, epoxy resins, allyl phthalate resins, polyamide resins, and maleic acid resins. These resins may be used alone or in combination of two or more species thereof. When an encapsulated toner is formed, such a resin can also be used as a constituent resin of core particles or shell particles, or as a matrix resin in which to encapsulated colored fine particles are dispersed. As a particularly preferred binder resin, for example, a polyester resin having an acid value of at least 1 (mg-KOH/g) may be used. When a hydrophilic resin such as a polyester resin is used as the binder resin, it is preferred to stabilize the charging properties by processing the resin of the resin as follows. In order to suppress hydrolysis in an aqueous dispersion liquid thereof, a carboxyl group-capping agent, such as a carbodiimide compound (as one example of a commercially available product, “Carbodilite LA-1”, made by Nisshinbo Chemical Inc.) or an oxazoline compound, is added and kneaded therein in advance in an amount of from 0.1 to 1 part based on 100 parts of the resin, and further, a water-soluble dicarboxylic acid such as oxalic acid, malonic acid, succinic acid, glutaric acid, adipic acid, phthalic acid, or maleic acid; or a carboxylic acid such as acetic acid, propionic acid, benzoic acid, citric acid, malic acid, ascorbic acid, or abietic acid is mixed therein in an amount of from 0.01 to 0.1 part based on 100 parts of the resin, so as to adjust the acid value of the resin. Then, the thus-processed resin is finely pulverized and then dispersed in an aqueous medium, followed by an aggregation and fusion step.

### [Coloring Agent]

As the coloring agent to be used in the invention, those conventionally used for producing a toner, inclusive of: carbon black, and organic or inorganic yellow, cyan, or magenta pigments or dyes, can be used alone or in admixture. In order to form an erasable toner, a coloring-decoloring system in which a color-forming compound, a color-developing agent, and a decoloring agent are combined may preferably be used. The colored fine particles constituting this coloring-decoloring system can also be dispersed in the binder resin after encapsulation thereof.

### [Color-Forming Compound]

The color-forming compound is representatively a leuco dye, and examples thereof include compounds having a lactone ring in each molecule, such as triphenylmethane compounds, diphenylmethane compounds, spiropyran compounds, fluoran compounds, and rhodamine lactam compounds. These can be used alone or in admixture of two or more species thereof.

### [Color-Developing Agent]

The color-developing agent that allows the color-forming compound to develop a color is a compound having a phenolic hydroxy group in each molecule, such as a hydroxyacetophenone compound, a hydroxy-benzophenone compound, a gallic acid ester compound, a benzenetriol compound, a bisphenol compound, a triphenol compound, or a cresol compound; or a compound having a phosphate group in each molecule such as phosphoric acid, a phosphoric acid monoester, or a phosphoric acid diester. These can be used alone or in admixture of two or more species thereof.

### [Decoloring Agent]

As the decoloring agent, a known compound can be used as long as it can inhibit the color forming reaction between a leuco dye and a color-developing agent by heat so as to change the developed color to colorlessness in a three-component system containing a leuco dye (a color-forming compound), a color-developing agent, and a decoloring agent.

As the decoloring agent, particularly, a decoloring agent capable of forming a coloring-decoloring system utilizing the thermal hysteresis of a known decoloring agent disclosed in JP-A-60-264285, JP-A-2005-1369, or JP-A-2008-280523 has an excellent instantaneous erasing property. When a mixture of such a three-component system in a colored state is heated to a specific decoloring temperature (Th) or higher, the mixture can be de-colored. Further, even if the de-colored mixture is cooled to a temperature not higher than Th, the de-colored state is maintained. When the temperature of the mixture is further decreased, a coloring reaction between the leuco dye and the color-developing agent is caused again at a specific color restoring temperature Tc or below to restore the colored state, and therefore, it is possible to cause a reversible coloring and decoloring reaction. In particular, it is preferred that the decoloring agent to be used in the invention satisfies the following relationship: Th>Tr>Tc, wherein Tr represents room temperature. Examples of the decoloring agent capable of causing this thermal hysteresis include alcohols, esters, ketones, ethers, and acid amides. Of these, esters are particularly preferred.

Also, an encapsulating agent (shell material) for forming an outer shell of the coloring agent is not particularly limited and can be appropriately selected by those skilled in the art.

Examples of methods for encapsulating the coloring agent include an interfacial polymerization method, a coacervation method, an in-situ polymerization method, a drying-in-liquid method, and a curing-and-coating-in-liquid method. In particular, an in-situ method in which a melamine resin is used as a shell component, an interfacial polymerization method in which a urethane resin is used as a shell component, or the like, is preferred.

The coloring agent encapsulated as needed preferably has a cumulative 50% volume diameter (hereinafter simply referred to as “D50”) of from 0.5 to 3.5 μm. If D50 is outside the range of from 0.5 to 3.5 μm, encapsulation of the coloring agent can be obstructed so that the amount of released fine powder is increased.

Further, although it depends on the specific types of color-forming compound and color-developing agent, for example, by placing the encapsulated coloring agent at −20 to −30° C., the they are coupled to each other to form a color.

### [Release Agent]

As the release agent, a conventionally used release agent such as an aliphatic hydrocarbon wax, an oxide of an aliphatic hydrocarbon wax or a block copolymer thereof, a vegetable wax, an animal wax, a mineral wax, or a wax containing, as a main component, a fatty acid ester, may be used for adjusting a fixing temperature or a release property, or other purpose.

### [Charge Control Agent (CCA)]

In order to control the triboelectric chargeability of the toner, a charge control agent such as a metal-containing azo compound or a metal-containing salicylic acid derivative compound, may also be added as needed.

### [Surfactant]

Examples of surfactants which are used for dispersing colored fine particles prior to aggregation when the toner is produced by an aggregation method include anionic surfactants, such as sulfate-based, sulfonate-based, phosphate-based, and soap-based anionic surfactants; cationic surfactants, such as amine salt-based and quaternary ammonium salt-based cationic surfactants; and nonionic surfactants, such as polyethylene glycol-based, polyoxyethylene alkyl ether-based, alkyl phenol ethylene oxide adduct-based, and polyhydric alcohol-based nonionic surfactants. Further, as surfactants for stabilizing fusion of particles after the aggregation, alkaline (earth) metal polycarboxylates are preferably used, while the above-mentioned surfactants can also be used.

### [Aggregating Agent]

Examples of the aggregating agent which can be used in the aggregation step of the invention include metal salts such as sodium chloride, calcium chloride, calcium nitrate, barium chloride, magnesium chloride, zinc chloride, magnesium sulfate, aluminum chloride, aluminum sulfate, and potassium aluminum sulfate; inorganic metal salt polymers such as polyaluminum chloride, polyaluminum hydroxide, and calcium polysulfide; polymeric aggregating agents such as polymethacrylic esters, polyacrylic esters, polyacrylamides, and acrylamide sodium acrylate copolymers; coagulating agents such as polyamines, polydiallyl ammonium halides, melanin formaldehyde condensates, and dicyandiamide; alcohols, such as methanol, ethanol, 1-propanol, 2-propanol, 2-methyl-2-propanol, 2-methoxyethanol, 2-ethoxy-ethanol, and 2-butoxyethanol; organic solvents, such as acetonitrile and 1,4-dioxane; inorganic acids, such as hydrochloric acid and nitric acid; and organic acids, such as formic acid and acetic acid.

### [Neutralizing Agent]

For the purpose of increasing the dispersion stability of polyester fine particles prior to the aggregation in the case of using polyester resin as the binder or controlling the dispersion stability of aggregated particles during the fusion, it is possible to use an inorganic base, such as sodium hydroxide or potassium hydroxide; an amine compound, such as dimethylamine or trimethylamine; alkaline (earth) metal polycarboxylates; or the like, as the neutralizing agent as needed.

### [Mechanical Shearing Device]

Examples of a pulverizing device in a kneading-and-pulverization method or a mechanical shearing device for producing (colored) fine particles to be aggregated include medium-free stirrers, such as ULTRA TURRAX (made by IKA Japan K.K.), T.K. AUTO HOMO MIXER (made by PRIMIX Corporation), T.K. PIPELINE HOMO MIXER (made by PRIMIX Corporation), T.K. FILMICS (made by PRIMIX Corporation), CLEAR MIX (made by M Technique Co., Ltd.), CLEAR SS5 (made by M Technique Co., Ltd.), CAVITRON (made by EUROTEC, Co., Ltd.), and FINE FLOW MILL (made by Pacific Machinery & Engineering Co., Ltd.); medium stirrers such as VISCO MILL (made by Aimex Co., Ltd.), APEX MILL (made by Kotobuki Industries Co., Ltd.), STAR MILL (made by Ashizawa Finetech Co., Ltd.), DCP SUPER FLOW (made by Nippon Eirich Co., Ltd.), MP MILL (made by Inoue Manufacturing Co., Ltd.), SPIKE MILL (made by Inoue Manufacturing Co., Ltd.), MIGHTY MILL (made by Inoue Manufacturing Co., Ltd.), and SC MILL (made by Mitsui Mining Co., Ltd.); and high-pressure impact-type dispersing devices such as ALTIMIZER (made by Sugino Machine Limited), NANOMIZER (made by Yoshida Kikai Co. Ltd.), and NANO 3000 (made by Beryu Co., Ltd.).

### [Fusion]

In order to adjust the circularity of toner particles formed of aggregated colored fine particles, the temperature of an aqueous dispersion liquid containing the aggregated particles is preferably raised to above the glass transition temperature (Tg) of the binder resin or higher, more preferably to a temperature in a range of Tg+10° C. to Tg+25° C., to control the fusion of the aggregated particles.

In this manner, toner particles having a circularity of 0.8 or more, preferably from 0.9 to 1.0 and also having a volume-average particle diameter of from 3 to 8 μm, preferably from 3.5 to 7 μm are obtained.

### [External Additive]

To 100 parts of the thus-obtained toner particles, an Si compound such as silica (SiO₂) or ethyl silicate (e.g., “Ethyl Silicate 28”, made by Calcoat Co., Ltd.) having an average primary particle diameter of from 1 to 100 nm, preferably from about 8 to 120 nm in an amount of from 0.1 to 5.0 parts calculated as SiO₂, and also a Ti (complex) oxide such as titanium oxide (TiO₂), barium titanate (BaTiO₂), or strontium titanate (SrTiO₂) in an amount of from 0.1 to 3.0 parts calculated as TiO₂ are added as external additives and attached to the surfaces of the toner particles, whereby a toner having a volume-average diameter of from 3 to 8 μm, preferably from 4.5 to 7.5 μm based on a particle size distribution determined by the Coulter method (measurement lower limit diameter of 2 μm by use of a 100 μm aperture) is obtained.

### [Developer]

The thus-obtained toner and an electrophotographic carrier formed of, for example, straight silicone-coated magnetic carrier particles having a volume-average particle diameter of from 20 to 50 μm or the like are mixed such that a toner density is from about 6 to 12%, whereby a two-component electrophotographic developer is prepared.

### EXAMPLES

Hereinafter, the invention will be described more specifically with reference to Examples and Comparative Examples. The values of properties described in the specification including the following examples are based on values measured according to the following methods.

### (Dielectric Loss (tan δ) of Toner)

3 g of a toner containing external additives was weighed and formed into a pellet having a diameter of 5 cm and a thickness of 1.3±0.3 mm by pressing the toner at 1.5 tf/cm² for 10 minutes. The thus-formed pellet was left standing in an LL environment (10° C., 20% RH) or an HH environment (30° C., 85% RH) for 8 hours, and thereafter the pellet was interposed between a pair of electrodes to form a cell. From the measurement value of the conductance (G) and capacitance (C) of the cell measured by applying an alternating current square wave voltage (5 V, 1 kHz) in an LCR meter and also from an average of the thickness of the cell, the dielectric losses (tan δ) in the LL environment and the HH environment were determined, respectively.

(Triboelectric Charge (q/m) of Toner)

In the LL environment or the HH environment, a toner containing external additives and a straight silicone-coated magnetic carrier (having a volume-average particle diameter of about 35 μm) were mixed such that a toner concentration was about 8%, and the resulting developer was left standing for 8 hours in either of the environmental conditions. Thereafter, the developer was stirred with a Turbla shaker for 30 minutes to charge the developer. Then, the triboelectric charge of the thus-charged developer was obtained as follows using a powder charge measuring instrument (TYPE TB-203, made by KYOCERA Chemical Corporation). 0.05 g of the charged developer was placed in a metal-made measurement vessel (Faraday cage) equipped with a 500-mesh screen and subjected to suction for 10 seconds with a suction device to remove the toner, and the charge (μC) was determined from the voltage (V) of the measurement vessel and the capacitance thereof. Then, the thus-obtained charge (μC) was divided by the weight of the toner to obtain the triboelectric charge (q/m) (unit: μC/g, sign: minus (−)). After it was confirmed that a difference in measured value between two consecutive measurements was within 3 μC/g, an average thereof was calculated and determined to be a measurement value.

### (Particle Size Distribution of Toner)

The particle size distribution of a toner was measured using a particle size distribution measuring instrument made by Beckman Coulter, Inc. (“Multisizer 3”, using a 100 μm aperture (measured particle size range: 2.0 to 60 μm)), and a volume-average diameter Dv and a coefficient of variation CV (%) (=standard deviation/Dv×100) were determined.

### (Circularity of Toner and External Additives)

Using a flow-type particle image analyzer (FPIA-2100 made by Sysmex Corporation), a sample particle in a sample particle suspension was irradiated with pulsed light and an image of the particle was taken. Then, from the image of the particle, a diameter D1 of a circle having the same area as the cross-sectional area S of the particle was obtained (D1=2·(S/π)^{1/2}), and also a diameter D2 of a circle having the same circumferential length L of the particle was obtained (D2=L/n). Then, a circularity was determined by a ratio D1/D2 (=2·(S/π)^{1/2}/(L/π)=2·(πS)^{1/2}/L.

### (Diameter of (Colored) Fine Particles and External Additive Particles in Dispersion Liquid)

The diameter was measured using a laser particle size distribution analyzer (“SALD-7000” made by Shimadzu Corporation, measured particle size range: 10 nm to 300 μm), and a volume-average diameter was determined.

### (Molecular Weight of Resin)

A weight-average molecular weight was determined based on polystyrene as a standard material by means of a GPC apparatus “Waters 2695” made by Waters Inc.

### Example 1

### 1) Preparation of Resin Fine Particles

Resin fine particle materials of the following composition were mixed, and the resulting mixture was processed by a twin-screw kneader set to a temperature of 120° C., whereby a kneaded material was obtained. The thus-obtained kneaded material was pulverized using a hammer mill, to obtain a mixture in the form of coarse particles.

### (Composition of Resin Fine Particles)

Polyester resin (molecular weight: 5000, AV (acid value):10): 88 wt.parts

Polyester resin (molecular weight: 40000, AV:20): 10 wt.parts

Carbodiimide compound (“Carbodilite LA-1”, made by Nisshinbo Chemical Inc.): 1 wt.part

Malonic acid: 0.1 wt.part

Charge control agent (a salicylic acid-based compound): 0.9 wt.part

40 wt.parts of the above-prepared mixture in the form of coarse particles, 0.4 wt.part of polyoxyethylene alkyl ether, 1 wt.part of dimethylaminoethanol, and 58.6 wt.parts of ion exchanged water, were charged into a high-pressure impact-type dispersing device (“NANO 3000”, made by Beryu Co., Ltd.) and once passed through the device once at a slurry temperature of 150° C., whereby a finely pulverized material was obtained. After completion of the processing, the material was cooled to 30° C., to obtain an emulsion containing emulsified resin fine particles having a volume-average particle diameter of 100 nm.

### 2) Preparation of Colored Fine Particles

Colored fine particle materials of the following composition were mixed, and the resulting mixture was processed by a twin-screw kneader set to a temperature of 120° C., whereby a kneaded material was obtained. The thus-obtained kneaded material was pulverized using a hammer mill, whereby a mixture in the form of coarse particles was obtained.

### (Composition of Colored Fine Particles)

Polyester resin (molecular weight: 5000, AV:10): 89.5 wt.parts

Cyan pigment (Pigment Blue 2): 5 wt.parts

Ester wax: 5 wt.parts

“Carbodilite LA-1”: 0.4 wt.part

Malonic acid: 0.1 wt.part

40 wt.parts of the above-prepared mixture in the form of coarse particles, 0.4 wt.part of sodium dodecylbenzenesulfonate, 1 wt.part of dimethylaminoethanol, and 58.6 wt.parts of ion exchanged water, were charged into a high-pressure impact-type dispersing device (“NANO 3000”, made by Beryu Co., Ltd.) and once passed through the device once at a slurry temperature of 150° C., whereby a finely pulverized material was obtained. After completion of the processing, the material was cooled to 30° C., to obtain an emulsion containing emulsified resin fine particles having a volume-average particle diameter of 350 nm.

### 3) Preparation of Colored Aggregated Material

While stirring at 30° C., 5 wt.parts of the colored fine particles, 0.2 wt.part of 1 N-hydrochloric acid, and 94.8 wt.parts of ion exchanged water were mixed, and then, dimethylamino ethanol was added thereto to adjust the pH of the mixture to 6, followed by heating to 50° C., whereby a dispersion liquid of aggregated particles having a volume-average particle diameter of 4.9 μm was obtained.

### 4) Preparation of Encapsulated Particles

While stirring at 50° C., 78 wt.parts of the dispersion liquid of colored aggregated particles and 14 wt.parts of the emulsion of the resin fine particles were mixed, and then, 8 wt.parts of an aqueous solution of 15% ammonium chloride was added thereto, followed by heating to 93° C., thereby obtaining encapsulated particles (pseudo-capsule particles obtained by attaching the resin fine particles to the circumference of the aggregated colored fine particles and melting the resin fine particles so as to cover the aggregated colored fine particles) having a volume-average particle diameter of 5.2 μm.

The thus-obtained encapsulated particles were washed using a centrifugal separator until the electrical conductivity of the liquid after washing became 50 μS/cm. Then, the washed encapsulated particles were dried using a vacuum dryer until the water content therein became 0.3 wt %, whereby toner particles were obtained.

After drying, 2 wt.parts in total of hydrophobic silica having an average particle diameter of 10 nm and hydrophobic silica having an average particle diameter of 100 nm, and 0.5 wt.part of titanium oxide having an average particle diameter of 10 nm, were attached to the surfaces of the colored particles, whereby a toner was obtained.

The thus-obtained toner had a volume-average particle diameter of 5.2 μm, a circularity of 0.98, a dielectric loss (tan δ) of 4.1×10³ in the LL environment, a dielectric loss (tan δ) of 7.9×10³ in the HH environment, a charge (q/m) of 39.3 μC/g in the LL environment, and a charge (q/m) of 20.3) μC/g in the HH environment.

### Example 2

### 1) Preparation of Resin Fine Particles

Resin fine particle materials of the following composition were mixed, and the resulting mixture was processed by a twin-screw kneader set to a temperature of 120° C., whereby a kneaded material was obtained. The thus-obtained kneaded material was pulverized using a hammer mill, to obtain a mixture in the form of coarse particles.

### (Composition of Resin Fine Particles)

Polyester resin (molecular weight: 5000, AV:10): 88 wt.parts

Polyester resin (molecular weight: 40000, AV:20): 11.1 wt.parts

Charge control agent (a salicylic acid-based compound): 0.9 wt.part

40 wt.parts of the above-prepared mixture in the form of coarse particles, 0.4 wt.part of polyoxyethylene alkyl ether, 1 wt.part of dimethylaminoethanol, and 58.6 wt.parts of ion exchanged water, were charged into a high-pressure impact-type dispersing device (“NANO 3000”, made by Beryu Co., Ltd.) and once passed through the device once at a slurry temperature of 150° C., whereby a finely pulverized material was obtained. After completion of the processing, the material was cooled to 30° C., to obtain an emulsion containing emulsified resin fine particles having a volume-average particle diameter of 100 nm.

### 2) Preparation of Colored Fine Particles

Colored fine particle materials of the following composition were mixed, and the resulting mixture was processed by a twin-screw kneader set to a temperature of 120° C., whereby a kneaded material was obtained. The thus-obtained kneaded material was pulverized using a hammer mill, whereby a mixture in the form of coarse particles was obtained.

### (Composition of Colored Fine Particles)

Polyester resin (molecular weight: 5000, AV:10): 89.5 wt.parts

Cyan pigment (Pigment Blue 2): 5 wt.parts

Ester wax: 5 wt.parts

“Carbodilite LA-1”: 0.4 wt.part

Malonic acid: 0.1 wt.part

40 wt.parts of the above-prepared mixture in the form of coarse particles, 0.4 wt.part of sodium dodecylbenzenesulfonate, 1 wt.part of dimethylaminoethanol, and 58.6 wt.parts of ion exchanged water, were charged into a high-pressure impact-type dispersing device (“NANO 3000”, made by Beryu Co., Ltd.) and once passed through the device once at a slurry temperature of 150° C., whereby a finely pulverized material was obtained. After completion of the processing, the material was cooled to 30° C., to obtain an emulsion containing emulsified resin fine particles having a volume-average particle diameter of 350 nm.

### 3) Preparation of Colored Aggregated Material

While stirring at 30° C., 5 wt.parts of the colored fine particles, 0.2 wt.part of 1 N-hydrochloric acid, and 94.8 wt.parts of ion exchanged water were mixed, and then, dimethylamino ethanol was added thereto to adjust the pH of the mixture to 6, followed by heating to 50° C., whereby a dispersion liquid of aggregated particles having a volume-average particle diameter of 4.9 μm was obtained.

### 4) Preparation of Encapsulated Particles

While stirring at 50° C., 78 wt.parts of the dispersion liquid of colored aggregated particles and 14 wt.parts of the emulsion of the resin fine particles were mixed, and then, 8 wt.parts of an aqueous solution of 15% ammonium chloride was added thereto, followed by heating to 93° C., thereby obtaining encapsulated particles (pseudo-capsule particles) having a volume-average particle diameter of 5.2

The thus-obtained encapsulated particles were washed using a centrifugal separator until the electrical conductivity of the liquid after washing became 50 μS/cm. Then, the washed encapsulated particles were dried using a vacuum dryer until the water content therein became 0.3 wt %, whereby toner particles were obtained.

After drying, 2 wt.parts in total of hydrophobic silica having an average particle diameter of 10 nm and hydrophobic silica having an average particle diameter of 100 nm, and 0.5 wt.part of titanium oxide having an average particle diameter of 10 nm, were attached to the surfaces of the colored particles, whereby a toner was obtained.

The thus-obtained toner had a volume-average particle diameter of 5.2 μm, a circularity of 0.95, a dielectric loss (tan δ) of 3.2×10³ in the LL environment, a dielectric loss (tan δ) of 6.5×10³ in the HH environment, a charge (q/m) of 35.4 μC/g in the LL environment, and a charge (q/m) of 25.0 μC/g in the HH environment.

### Comparative Example 1

A toner was obtained and the properties of the toner were evaluated in the same manner as in Example 1, except for using the following compositions of Resin Fine Particles and Colored Fine Particles, that is, except for omitting “Carbodilite LA-1” and the malonic acid from the following compositions.

### (Composition of Resin Fine Particles)

Polyester resin (molecular weight: 5000, AV:10): 89 wt.parts

Polyester resin (molecular weight: 40000, AV:20): 10 wt.parts

Charge control agent (a salicylic acid-based compound): 1 wt.part

### (Composition of Colored Fine Particles)

Polyester resin (molecular weight: 5000, AV:10): 90 wt.parts

Cyan pigment (Pigment Blue 2): 5 wt.parts

Ester wax: 5 wt.parts

The resultant toner had a volume-average particle diameter of 5.2 μm, a circularity of 0.97, a dielectric loss (tan δ) of 6.4×10³ in the LL environment, a dielectric loss (tan δ) of 16.2×10³ in the HH environment, a charge (q/m) of 54.8 μC/g in the LL environment, and a charge (q/m) of 21.3 μC/g in the HH environment.

### Comparative Example 2

A toner was obtained and the properties of the toner were evaluated in the same manner as in Comparative Example 1, except for using the following composition of Resin Fine Particles

### (Composition of Resin Fine Particles)

Polyester resin (molecular weight: 40000, AV:20): 99 wt.parts

Charge control agent (a salicylic acid-based compound): 1 wt.part

The resultant toner had a volume-average particle diameter of 5.2 μm, a circularity of 0.97, a dielectric loss (tan δ) of 10.9×10³ in the LL environment, a dielectric loss (tan δ) of 20.7×10³ in the HH environment, a charge (q/m) of 65.5 μC/g in the LL environment, and a charge (q/m) of 34.6 μC/g in the HH environment.

### Comparative Example 3

A toner was obtained and the properties of the toner were evaluated in the same manner as in Comparative Example 1, except for using the following composition of Resin Fine Particles

### (Composition of Resin Fine Particles)

Polyester resin (molecular weight: 5000, AV:10): 99 wt.parts

Charge control agent (a salicylic acid-based compound): 1 wt.part

The resultant toner had a volume-average particle diameter of 5.0 μm, a circularity of 0.97, a dielectric loss (tan δ) of 6.8×10³ in the LL environment, a dielectric loss (tan δ) of 16.6×10³ in the HH environment, a charge (q/m) of 55.5 μC/g in the LL environment, and a charge (q/m) of 22.0 μC/g in the HH environment.

### Comparative Example 4

A toner was obtained and the properties of the toner were evaluated in the same manner as in Comparative Example 1, except for using the following composition of Resin Fine Particles

### (Composition of Resin Fine Particles)

Polyester resin (molecular weight: 5000, AV:10): 90 wt.parts

Polyester resin (molecular weight: 40000, AV:20): 10 wt.parts

The resultant toner had a volume-average particle diameter of 5.2 μm, a circularity of 0.97, a dielectric loss (tan δ) of 8.6×10³ in the LL environment, a dielectric loss (tan δ) of 20.6×10³ in the HH environment, a charge (q/m) of 58.4 μC/g in the LL environment, and a charge (q/m) of 18.4 μC/g in the HH environment.

### [Evaluation of Electrographic Performances]

A developer obtained by mixing 6.5 wt.parts of each of the toners obtained in the above Examples and Comparative Examples with a straight silicone-coated magnetic carrier (having a volume-average particle diameter of 35 μm) so as to provide a toner concentration of about 6.5% was placed in an electrophotographic copier “e-STUDIO 4511” made by Toshiba Tec Corporation, and was subjected to a continuous printing test in which printing was performed at a coverage of 8% on 100,000 (100 k) sheets of A4 paper in an environment of 35° C. and 85% relative humidity (HH). Then, evaluation was performed with respect to the following evaluation items.

### (Toner Scattering)

The presence of toner scattered around the developing device was checked by observation with eyes, and the amount of toner adhered to a filter attached to a cover of the developing device, after completion of the above continuous printing test was recorded.

### (Fogging)

A Lab coordinate value was obtained by performing measurement using a spectro-densitometer “X-RITE 939” in a white background region of paper at a point after printing on about 100,000 (10K) sheets of paper in the above continuous printing test, and a difference between the Lab coordinate value and the origin was obtained.

The case where the difference was less than 1.0 was rated as “A”, and the case where the difference was 2.0 or more was rated as “C”.

The evaluation results of the toners of Examples and Comparative Examples are summarized in the following Table 1 along with the values of dielectric losses (tan δ) and triboelectric charges (q/m).

TABLE 1

| | | | | | | | Toner | |
|---|---|---|---|---|---|---|---|---|
| | Dielectric | | | Triboelectric | | | scatter- | |
| | loss (tan δ) | | | charge (q/m) | | | ing** | |
| | (×10³) | | | (μC/g) | | | Amount | Fog- |
| | LL | HH | HH-LL | LL | HH | LL-HH | (mg) | ging |
| Example 1 | 4.1 | 7.9 | 3.8 | 39.3 | 20.3 | 19.0 | 9.8 | A |
| Example 2 | 3.2 | 6.5 | 3.3 | 35.4 | 25.0 | 10.4 | 9.2 | A |
| Compar- | 6.4 | 16.2 | 9.8 | 54.8 | 21.3 | 33.5 | 40.0 | C |
| ative | | | | | | | | |
| Example 1 | | | | | | | | |
| Compar- | 10.9 | 20.7 | 9.8 | 65.5 | 34.6 | 30.8 | 44.3 | C |
| ative | | | | | | | | |
| Example 2 | | | | | | | | |
| Compar- | 6.8 | 16.6 | 9.8 | 55.5 | 22.0 | 33.5 | 54.3 | C |
| ative | | | | | | | | |
| Example 3 | | | | | | | | |
| Compar- | 8.6 | 20.6 | 12.0 | 58.4 | 18.4 | 40.0 | 59.9 | C |
| ative | | | | | | | | |
| Example 4 | | | | | | | | |

**No leakage of toner out of the developing device was observed in Examples, whereas conspicuous toner leakage out of the developing device was observed in Comparative Examples.

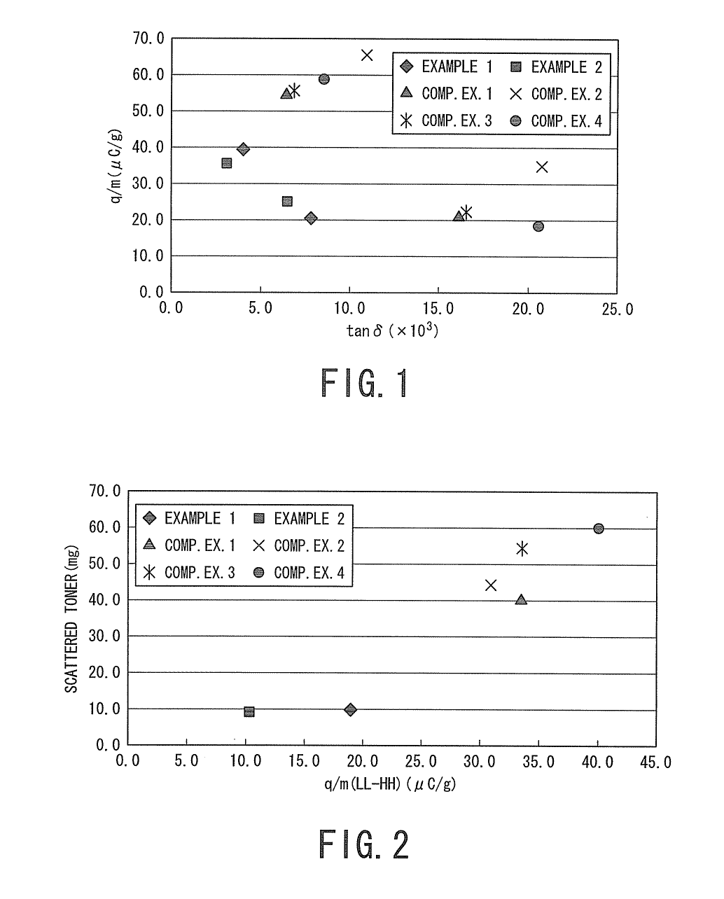

Based on the results of the above Table 1, FIG. 1 shows overall plots of the dielectric losses (tan δ) and triboelectric charges (q/m) of the toners obtained in Examples and Comparative Examples in the LL environment and the HH environment, and FIG. 2 shows correlative plots between the difference in triboelectric charge (q/m (LL-HH)) between those measured in an LL environment and those measured in an HH environment and the amount of scattered toner for toners obtained in Examples and Comparative Examples. FIG. 1 shows that the plots of the toners according to Examples were gathered in a lower left region regardless of either in the LL environment or in the HH environment. FIG. 2 shows that the toners according to Examples exhibited a smaller difference in triboelectric charge (q/m (LL-HH)) (q/m) caused by a change in environment, and accordingly exhibited a significantly smaller amount of scattered toner.

What is claimed is:

1. An electrophotographic toner, comprising toner particles which contain at least a binder resin and a coloring agent and are prepared in an aqueous medium, wherein the surfaces of the toner particles are treated with an Si compound in an amount of from 0.1 to 5.0 wt % calculated as SiO₂ and a Ti oxide in an amount of from 0.1 to 3.0 wt % calculated as TiO₂, respectively based on the toner particles, and the toner has a dielectric loss (tan δ) of from 1×10³ to 10×10³ in an environment of 10° C. and 20% relative humidity (RH) and from 3×10³ to 15×10³ in an environment of 30° C. and 85% RH, and also has a triboelectric charge (q/m) of from 20 to 50 μC/g in an environment of 10° C. and 20% RH and from 10 to 35 μC/g in an environment of 30° C. and 85% RH.

2. The toner according to claim 1, wherein the binder resin comprises a polyester resin having an ester bond modified with a carboxyl group-capping agent.

3. The toner according to claim 1, wherein the carboxyl group-capping agent is a carbodiimide.

4. The toner according to claim 3, wherein the binder resin comprises a polyester resin which has been kneaded with the carbodiimide in an amount of from 0.1 to 1 wt.part based on 100 wt.parts thereof in advance.

5. The toner according to claim 4, wherein the binder resin is a polyester resin which is further mixed with a water-soluble carboxylic acid in an amount of from 0.01 to 0.1 wt.part based on 100 wt.parts thereof.

6. The toner according to claim 1, wherein the toner has a volume-average particle diameter of from 4.5 to 7.5 μm and is mixed with an electrophotographic carrier having a volume-average particle diameter of from 20 to 50 μm and surface-coated with straight silicone.

7. The toner according to claim 1, wherein the toner particles have a circularity of from 0.8 to 1.

8. The toner according to claim 1, wherein the toner particles have a pseudo-capsule structure in which aggregated fine particles containing the coloring agent are coated with a melted material of the binder resin.

9. The toner according to claim 1, wherein fine particles of the Si compound and the Ti oxide have an average particle diameter of from 1 to 1000 nm and a circularity of from 0.1 to 1.

10. The toner according to claim 1, wherein the coloring agent contains at least a leuco dye and a color-developing agent and can be decolored.

11. The toner according to claim 1, further comprising a release agent.
